(19) United States
(12) Patent Application Publication
(10) Pub. No.: US 2023/0407888 A1
(43) Pub. Date: Dec. 21, 2023

(54) JET PUMP FOR GASEOUS MEDIUM

(71) Applicant: ECO Holding 1 GmbH, Marktheidenfeld (DE)

(72) Inventors: Dietmar Schulze, Muenzenberg (DE); Mario Witopil, Marktheidenfeld (DE)

(21) Appl. No.: 18/209,340

(22) Filed: Jun. 13, 2023

(30) Foreign Application Priority Data
Jun. 17, 2022 (DE) DE102022115196.4

(51) Int. Cl. F04F 5/46; H01M 8/04111

(52) U.S. Cl. CPC F04F 5/461; H01M 8/04111

(57) ABSTRACT

A jet pump configured to control a feed of a gaseous medium, the jet pump comprising: a primary nozzle configured to feed a propellant and including a nozzle body and a nozzle needle longitudinally movable within the nozzle body so that a nozzle cross section of the primary nozzle is variably adjustable and closeable by the nozzle needle; a compression spring that urges the nozzle needle in a closing direction, wherein the nozzle needle includes a first pressure surface configured to be loaded with a pressure of the propellant in an opening direction that is opposite to the closing direction, and a second pressure surface configured to be loaded with a pressure of a secondary medium in the closing direction.

### RELATED APPLICATIONS

This application claims priority from and incorporates by reference German patent application DE 10 2022 115 196.4 filed on Jun. 17, 2022.

### FIELD OF THE INVENTION

The invention relates to a jet pump for controlling a gaseous medium, in particular hydrogen.

### BACKGROUND OF THE INVENTION

A jet pump also designated as an ejector uses kinetic energy of a propellant jet of a primary or propellant medium to suction a fluid surrounding a propellant nozzle or primary nozzle, also designated as secondary or suction medium that is pulled along and raised to a higher-pressure level. Thus, an achievable velocity of the propellant jet and thus available kinetic energy is determined among other things by a size of the smallest flow cross section within the propellant nozzle for a predetermined pressure upstream of the propellant nozzle.

In particular for ejectors with a large operating range, like e.g. in a mobile fuel cell application, the sizing of the propellant nozzle is non-trivial. On the one hand side the propellant nozzle must be large enough to provide the maximum required primary mass flow for a predetermined pressure. On the other hand side, the velocity of the propellant jet has to be large enough even for a small primary mass flow in order to pull along a sufficient amount of the secondary medium.

Known solutions for this problem describe a propellant nozzle with a variable flow cross section. Thus, a nozzle needle arranged within the nozzle is typically moved along a longitudinal axis. This is performed by a direct actuation of the nozzle needle by a linear actuator.

An alternative solution uses plural propellant nozzles which are added in cascades. However, plural nozzles require plural valves for control which significantly increases parts requirements and complexity of the system.

The nozzle needle that is movable along a longitudinal axis is less complex, however the control by linear actuator also has disadvantages. Stepper motors that are used as control elements have insufficient dynamic response to regulate a pressure in a fuel cell in a mobile application. Furthermore, the stepper motors have a complex configuration and have to be sealed against the drive fluid.

### BRIEF SUMMARY OF THE INVENTION

Thus, it is an object of the invention to provide an improved jet pump, it is another object of the invention to provide a fuel cell system with an improved jet pump.

It is another object of the invention to provide a method for controlling a propellant nozzle geometry of a jet pump which facilitates a use of jet pump with a simple configuration in a large operating range.

The object is achieved by a jet pump configured to control a feed of a gaseous medium, the jet pump including a primary nozzle configured to feed a propellant and including a nozzle body and a nozzle needle longitudinally movable within the nozzle body so that a nozzle cross section of the primary nozzle is variably adjustable and closeable by the nozzle needle; a compression spring that urges the nozzle needle in a closing direction, wherein the nozzle needle includes a first pressure surface configured to be loaded with a pressure of the propellant in an opening direction that is opposite to the closing direction, and a second pressure surface configured to be loaded with a pressure of a secondary medium in the closing direction.

According to the invention a compression spring is provided that urges the nozzle needle in a closing direction. Furthermore, the nozzle needle includes at least one first pressure surface configured to be loaded with a pressure of the propellant in an opening direction that is opposite to a closing direction and at least one second pressure surface configured to be loaded with a pressure of a secondary medium in the closing direction.

The jet pump according to the invention has a simple configuration and direct activation of the primary nozzle is not necessary. Rather, the actuation is performed indirectly by loading the pressure surfaces of the nozzle needle with a force.

Advantageously the nozzle body is configured in two or more components and includes a first nozzle body element with a first inflow opening for the propellant and a second nozzle body element with a second opening for the secondary medium, wherein the nozzle needle is provided in the first nozzle body element longitudinally movable and the compression spring is arranged between the nozzle needle and the second nozzle body element and wherein the compression spring contacts the second pressure surface. The primary nozzle is configured in a simple manner so that the nozzle needle can be mounted in a simple manner and protected against loss.

The object is also achieved by a fuel cell system including a jet pump configured to control a hydrogen feed of a fuel cell. The basic configuration of a fuel cell system for a motor vehicle is known. Fuel cell systems with an anode supply and a cathode supply are well known. Fuel cell systems use the chemical transformation of a fuel with oxygen into water to generate electrical energy. In order to supply a fuel cell stack of the fuel cell system with operating media, an anode supply for feeding and exhausting the anode operating agent, e.g. hydrogen, and a cathode supply for feeding and exhausting the cathode operating agent, e.g. air, and a coolant loop are provided. The anode supply and the cathode supply respectively include a supply conduit for feeding the operating agent and an exhaust gas conduit. A recirculation conduit can be additionally provided in the anode supply in order to feed hydrogen included in the anode side exhaust gas of the fuel cell stack back into the fuel cell stack.

The object is also achieved by a method for controlling a propellant nozzle geometry of a jet pump wherein the nozzle cross section is adjustable by indirect control of the nozzle needle. The nozzle needle is not actuated by a linear actuator so that a quick dynamic control of the pressure in the fuel cell is provided.

Advantageously the position of the nozzle needle and the nozzle cross section is adjustable by forces impacting the pressure surfaces, wherein the propellant medium generates a first force in an opening direction and the secondary medium and the compression spring generate a second force in the closing direction.

Advantageously forces at the nozzle needle are in equilibrium for a predetermined operating point of the nozzle needle so that the nozzle needle assumes a defined position.

The subsequent detailed description and the entirety of the patent claims define additional advantageous embodiments and feature combinations according to the invention.

### BRIEF DESCRIPTIONS OF THE DRAWINGS

The invention is now subsequently described based on advantageous embodiments with reference to drawing figures, wherein:

FIG. 1 illustrates a schematic view of a jet pump including a primary nozzle; and

FIG. 2 illustrates the primary nozzle of the jet pump according to FIG. 1.

### DETAILED DESCRIPTION OF THE INVENTION

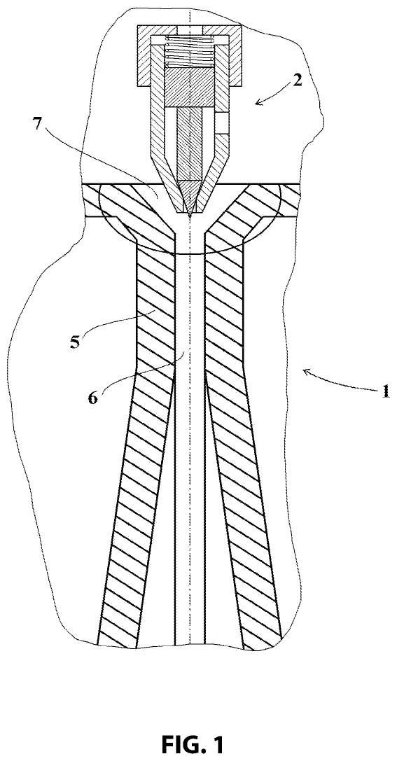

FIG. 1 shows a schematic view of a jet pump 1 configured to control a feed of a gaseous medium, in particular hydrogen. The jet pump 1 also designated as ejector is used e.g. in a fuel cell system of a non-illustrated vehicle, in particular of an electric vehicle including an electric traction motor which is provided with electrical energy by the fuel cell system.

The fuel cell system typically includes a fuel cell stack which can be typically configured as a stack of PEM fuel cells. A common cathode cavity is provided with a cathode supply for feeding and exhausting cathode operating agent, e.g. air, and a common anode cavity is provided with an anode supply for feeding and exhausting the anode operating agent, e.g. hydrogen.

The cathode supply includes a cathode supply conduit which feeds air pulled from ambient to the common cathode cavity of the fuel cell stack. A cathode exhaust gas conduit exhausts cathode exhaust gas from the cathode cavity. Optionally the cathode exhaust gas is fed to a non-illustrated exhaust system.

The anode supply includes an anode supply conduit which provides the anode operating agent, in particular hydrogen from a hydrogen tank to the anode cavity. The anode supply conduit typically includes a pressure regulation valve, a tank valve, a dosing valve and a cut off valve. An anode exhaust gas conduit exhausts anode exhaust gas from the anode cavity. The anode supply furthermore includes a recirculation conduit configured to feed hydrogen included in the anode side exhaust gas of the fuel cell stack back into the fuel cell stack by a recirculation device, e.g. the jet pump 1.

Furthermore, the anode exhaust gas conduit can include a water separator including a downstream drain valve configured to drain product water generated by the fuel cell reaction and a purge valve configured to drain the anode gasses, mostly nitrogen.

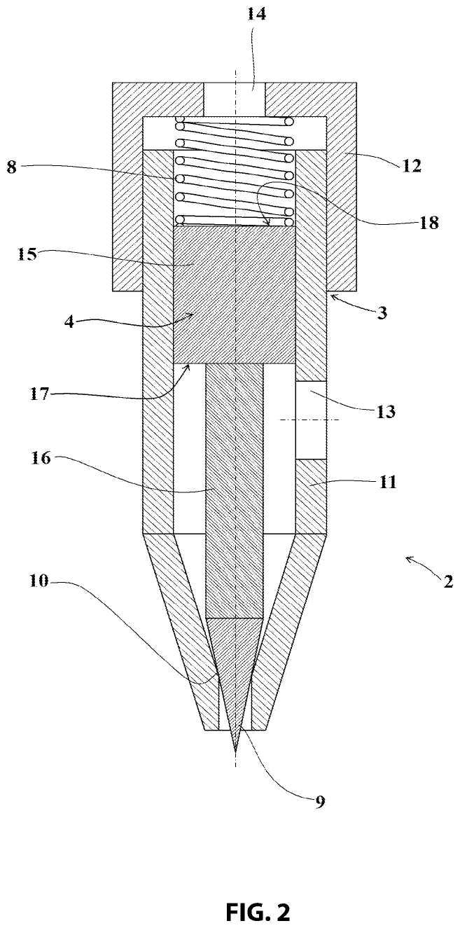

As evident from FIG. 1, the jet pump 1 illustrated in sections only includes a primary nozzle 2 shown in FIG. 2 in a blown-up view configured to feed a propellant, in particular hydrogen, the primary nozzle including a nozzle body 3 and a nozzle needle 4 movable within the nozzle body 3, wherein a nozzle cross section is variably adjustable and closable by the nozzle needle 4. The jet pump 1 also includes a pump housing 5 with a pass-through bore hole 6, wherein the pump housing conducts a secondary medium mixed with the propellant through the anode supply conduit towards the anode cavity. The secondary medium is pulled in through a suction channel 7.

It is evident from FIG. 2 that the primary nozzle includes a compression spring 8 that urges the jet needle 4 into a closing direction where an end tip 9 of the nozzle needle 4 closes and opening 10 of the nozzle body 3.

The nozzle body 3 is configured in two components in this embodiment including a first nozzle body element 11 including a first inflow opening 13 for the propellant and a second nozzle body element 12 including a second inflow opening 14 for the secondary medium, wherein the jet needle 4 is provided longitudinally movable with a cylindrical piston 15 in the first nozzle body element 11. The compression spring 8 is arranged between the piston 15 and the second nozzle body element 12. As evident from FIG. 2 the second nozzle body element 12 partially envelops the first nozzle body element 11 and thus forms a receiving cavity for the compression spring 8 and the nozzle needle 4. The needle 16 is integrally formed at the piston 15 wherein the tip 9 is formed at the needle 16.

For pressure loading, the nozzle needle 4 includes at least one first pressure surface 17, configured to be loaded with a pressure of the propellant in an opening direction oriented opposite to the closing direction and at least one second pressure surface 18 configured to be loaded with a pressure of a secondary medium in the closing direction. As evident from FIG. 2, the first pressure surface 17 is an annular surface which is loaded with pressure by a propellant that flows through the first flow in opening 13. The propellant is fed under pressure by a conventional pressure control valve of the primary nozzle and displaces the nozzle needle 4 in the opening direction. Thus, the primary nozzle 2 opens and a nozzle cross section is enlarged by the corresponding geometries of the needle 16 and the opening 10 of the first nozzle body element 11.

The second pressure surface 18 that is formed on a side of the piston 15 that is opposite to the first pressure surface 17, loads the nozzle needle 4 with a lower pressure than the primary pressure of the propellant. Thus, the lower pressure is the pressure of the secondary medium which can be fed e.g. from the recirculation conduit recited supra back into the jet pump 1. By the same token this can be the ambient pressure or the pressure after the ejector.

The pressure of the secondary medium and the compression spring 8 which contacts the second pressure surface 18 generate an opposite force versus the force of the propellant medium wherein the opposite force moves the nozzle needle 4 to the right in the drawing figure, this means in the closing direction towards a smaller nozzle cross section. For a defined operating point, the forces at the nozzle needle from an equilibrium and the nozzle needle 4 assumes a defined position and thus determines the nozzle cross section.

Thus, it is possible to implement a higher nozzle exit velocity for a smaller supply pressure and a smaller primary mass flow due to the smaller flow cross section. For a higher supply pressure, the nozzle needle 4 opens further and the cross section thus increased facilitates the larger primary mass flow.

All features described and shown in conjunction with individual embodiments can be provided in different combinations according to the invention while still achieving their advantageous effect. The scope and spirit of the instant invention is defined by the patent claims and is not limited by the features described in the description or shown in the drawing figures.

What is claimed is:

1. A jet pump configured to control a feed of a gaseous medium, the jet pump comprising:
a primary nozzle configured to feed a propellant and including a nozzle body and a nozzle needle longitudinally movable within the nozzle body so that a nozzle cross section of the primary nozzle is variably adjustable and closeable by the nozzle needle;
a compression spring that urges the nozzle needle in a closing direction,
wherein the nozzle needle includes a first pressure surface configured to be loaded with a pressure of the propellant in an opening direction that is opposite to the closing direction, and a second pressure surface configured to be loaded with a pressure of a secondary medium in the closing direction.

2. The jet pump according to claim 1,
wherein the nozzle body is configured from at least two components including a first nozzle body component including a first flow in opening for the propellant, and a second nozzle body component including a second flow in opening for the secondary medium, and
wherein the nozzle needle is longitudinally movable in the first nozzle body component, the compression spring is provided between the nozzle needle and the second nozzle body element, and the compression spring contacts the second pressure surface.

3. A fuel cell system, comprising: the jet pump according to claim 1 configured to control a hydrogen feed of a fuel cell.

4. A method for controlling a propellant nozzle geometry of a jet pump according to claim 1, wherein the nozzle cross section is adjustable by an indirect control of the nozzle needle.

5. The method according to claim 4,
wherein a position of the nozzle needle and the nozzle cross section is adjustable by forces impacting the first pressure surface and the second pressure surface, and
wherein the propellant generates a first force in the opening direction and the secondary medium and the compression spring generate a second force in the closing direction.

6. The method according to claim 5, wherein the first force and the second force at the nozzle needle are in equilibrium for a predetermined operating point of the jet pump so that the nozzle needle assumes a defined position.

7. The jet pump according to claim 1, wherein the gaseous medium is hydrogen.
